(19) United States
(12) Patent Application Publication
(10) Pub. No.: US 2006/0115322 A1
(43) Pub. Date: Jun. 1, 2006

(54) Steel beam coupling device

(76) Inventors: Jong Won Park, Yuseong-gu (KR); In-Kyu Hwang, Chongwon-gu (KR)

Correspondence Address: GRAYBEAL, JACKSON, HALEY LLP, 155 - 108TH AVENUE NE, SUITE 350, BELLEVUE, WA, 98004-5901, US

(21) Appl. No.: 11/262,293

(22) Filed: Oct. 28, 2005

Related U.S. Application Data
(63) Continuation-in-part of application No. PCT/KR04/00984, filed on Apr. 29, 2004.

(30) Foreign Application Priority Data
Apr. 29, 2003 (KR) 2003-26996

(51) Int. Cl. B25G 3/00

(52) U.S. Cl. 403/256

(57) ABSTRACT

The present invention relates to a coupling device for connecting structural members. The coupling device can take up the difference in thickness of connected structural members without mechanical processing. It can also take up the variation in depth and deviation from straightness which can occur during the construction procedure while keeping the strong connection between the connected structural members. This coupling device, which is easy to fabricate at low cost, comprises a coupling case (200) that has connecting slots (210), in which the structural members (100) to be connected are placed, and fillers (300) that are placed in the slots (210) to touch the inside (212) of the slots (210), and one-body or separated wedges (400) that are placed between the fillers (300) and the connected structural members (100).

### TECHNICAL FIELD

The present invention relates to a coupling device for connecting structural members. The coupling device can take up the difference in thickness of connected structural members without mechanical processing. It can also take up the variation in depth and deviation from straightness, which can occur during the construction procedure while keeping the strong connection between the connected structural members, which is easy to fabricate at low cost, comprises a coupling case that has connecting slots, in which the structural members to be connected are placed, and fillers that are placed inside the slots, and the wedges that are placed between the fillers and the connected structural members.

### BACKGROUND ART

Bolted connection has been widely used as the means of structural connection in civil and architectural construction fields such as column splices, beam-to-column connections, beam splices, and brace connections. Bolted connection requires a large number of holes to be drilled in the connected structural members and the splice plates or brackets that are placed at one or both sides of the connected structural members to connect the structural members using bolts and nuts.

However, the large number of holes required for bolted connection cause problems such as reduced section, stress concentration, reduction in the energy absorption capacity, and increase in installation time under dangerous work environment. Moreover, slip between connected structural members may occur under tension or compression force, because the diameter of bolts is always smaller than that of holes. To prevent slip and stress concentration from occurring, friction-type connection has been used, in which high clamping force is induced for the friction force at the connected surface to resist the applied force. However, the problems of bolted connection can not be solved completely.

To solve the problems of bolted connection, the inventors of the present invention have disclosed a connecting technique (PCT/KR01//00572), in which the coupling device comprises a coupling case with connecting slots (20), in which the structural members to be connected (10) are placed, and wedges (30) that are inserted into the space between the coupling case and the connected member as shown in FIG. 1. The wedges (30) are made to have a higher coefficient of friction on the surface that touches the structural members (10) than on the surface that touches the coupling case. When external forces are acted on the member (10), as the external force increases, the vertical force that is induced to the member (10) by wedge (30) increases due to the difference between the coefficient of friction between the slope side of the wedge and the coupling case (20) and the coefficient of friction between the bottom side of the wedge and the member (10). Because of the wedge action of the wedge (30) between the member (10) and the coupling case (20), the member (10) does not come out of the coupling case (20), unless the coupling case fails.

The coupling device of PCT/KR01/00572 does not have the problems due to bolt holes such as reduced section, stress concentration, reduction in the energy absorption capacity, because it does not require bolt holes to be drilled in the connected structural members. The fabrication cost of the coupling device may be less than that of bolted connection which needs bolts, drilling, and connection plates such splice plates or brackets. Moreover, the coupling device is easy to install compared to bolted connection which needs installation of a large number of bolts reducing the construction time, labor cost, and accidents due to work at high places. However, the coupling device has some problems as follows:

First, it takes lots of cost and labor to mechanically process the connecting slots of the coupling case to match the dimensions of the wedge and the connected member with precision. Moreover, installation time may be increased, because it is not easy to insert the wedge between the coupling case and the member which are made with precision.

Second, since dimensional tolerances are allowed in the production of wide-flange beams, the coupling device must be able to take up the variation in the thickness of the beam flanges for easy and safe construction. However, there is an intrinsic problem that the variation can not be taken up using the connecting slot of the coupling case and the wedge only.

Third, there are limits to the application of the coupling device in case of any difference in depth and/or deviation from straightness at a connection.

### DISCLOSURE OF THE INVENTION

The present invention is devised to solve the problems of the coupling device as above mentioned. It is the objective of the present invention to provide an improved coupling device for structural steel connections that is easy to fabricate at low cost, and can take up any difference in thickness of connected structural members without mechanical processing, any variation in depth, and deviation from straightness which can occur during the construction procedure while keeping the strong connection between the connected structural members. For this purpose, the present invention provides a coupling device which comprises a coupling case that has connecting slots, in which the structural members to be connected are placed, and a pair of fillers that are placed inside the connecting slots to touch the surface of the slots, and the wedges that are placed between the fillers and the connected structural members.

In the coupling device of the present invention, the connecting slot of the coupling case is formed as a round hole whose diameter is larger than the width of the slit for the insertion of the connect member making it easier to fabricate than the connecting slot of the previous coupling device in which the two slope surfaces have to be mechanically processed with precision. The filler that is placed in the connecting slot has an outer surface that touches the coupling case and an inner surface that touches the wedge. The inner surface of the filler has slope side 1 and slope side 2 which are tapered outwards. The wedge has an outer surface that has slope side 1 and slope side 2 corresponding to the slope side 1 and slope side 2 of the filler and an inner side that touches the member.

In another Preferred Embodiment of the present invention, said wedge is divided along the borderline between slope side 1 and slope side 2, and springs are placed between the divided wedges to spread them.

In another Preferred Embodiment of the present invention, said wedge is divided transversely with the outer surfaces of the divided wedges formed to be tapered outwards, and the inner side of said filler is tapered inwards corresponding to the outer surface of said wedge. A space adjuster is provided between the divided wedges to spread them. After the coupling device is placed, the space adjuster is modulated to spread the divided wedges securing better wedge action.

In another Preferred Embodiment of the present invention, to ensure firm contact between the wedge and the member, which secures safety of the coupling device, a stud is attached to the surface of the member, and a corresponding hole is formed on the inner surface of said wedge.

### BRIEF DESCRIPTION OF THE DRAWINGS

FIG. 1 represents the coupling device and its principle of operation of the prior invention by the inventors of the present invention.

FIG. 2 represents the coupling device of the present invention in a disassembled state.

FIG. 3 represents a wide-flange beam splice using the coupling device of the present invention and its detail.

FIG. 4 shows the cross section of the coupling case of the coupling device of the present invention.

FIG. 5 shows the filler of the coupling device of the present invention.

FIG. 6 shows the wedge of the coupling device of the present invention.

FIG. 7 shows the cross section of the coupling device of the present invention as another Preferred Embodiment.

FIG. 8 illustrates the mobility of the structural members connected using the coupling device of FIG. 7.

FIG. 9 shows the coupling device of the present invention as another Preferred Embodiment in a disassembled state.

FIG. 10 shows the coupling device of FIG. 9 in an assembled state.

FIG. 11 shows the coupling device of the present invention as another Preferred Embodiment in a disassembled state.

FIG. 12 shows the coupling device of FIG. 11 in an assembled state.

FIG. 13 shows the wedge of the coupling device of FIG. 11.

FIG. 14 shows the filler of the coupling device of FIG. 11.

FIG. 15 shows the coupling device connecting structural members with different depth.

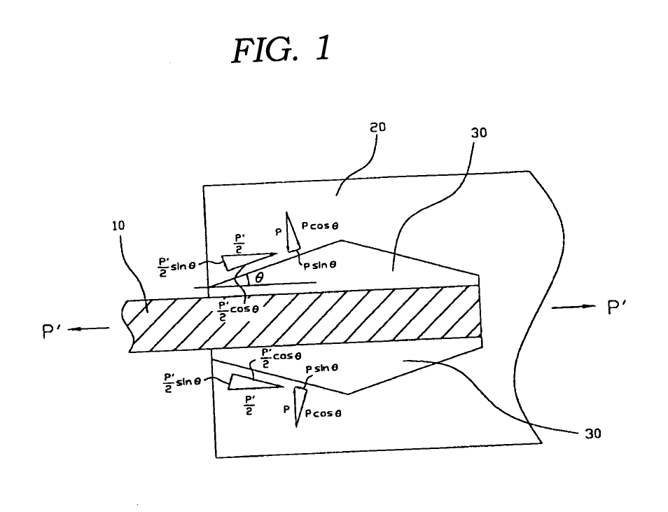

### EXAMPLES

Practical and presently preferred embodiments of the present invention, which may make modifications and improvements within the scope of the present invention, are illustrated using the figures.

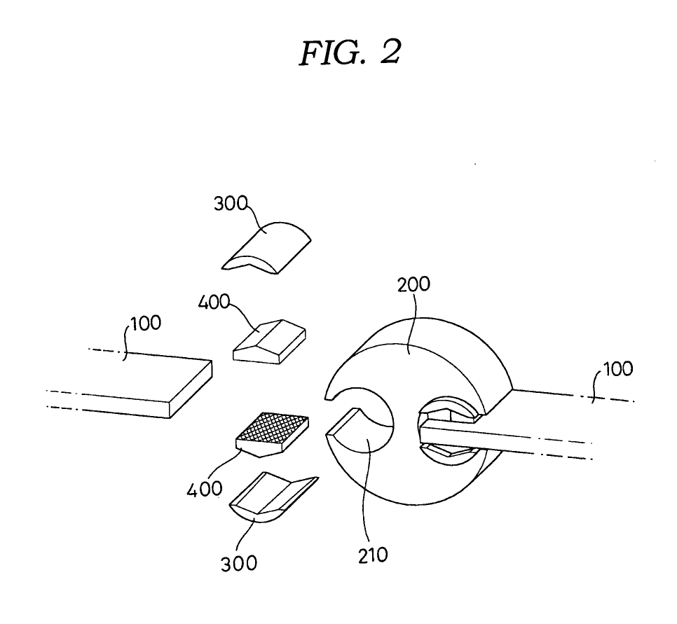

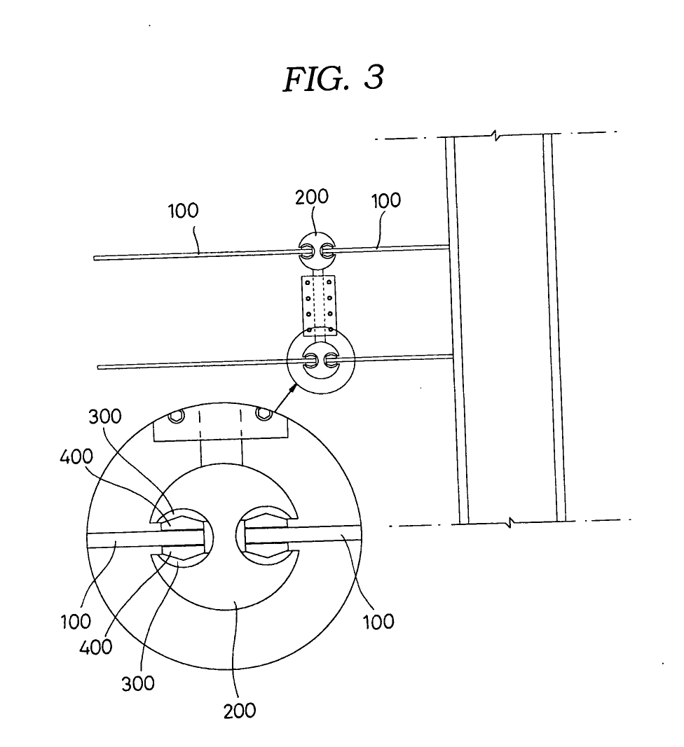

FIG. 2 represents the coupling device of the present invention in a disassembled state and FIG. 3 represents the coupling device of the present invention used for wide-flange beam splices of steel structures.

As shown in FIG. 2 and FIG. 3, the coupling device of the present invention comprises a coupling case (200) that has connecting slots (210), in which the connected structural members (100) are placed, and a pair of fillers (300) that are placed in the connecting slots (210) to touch the inside (212) of the slots (210), and the wedges (400) that are placed between the fillers (300) which are placed inside the slots (210) and the connected structural members (100).

In the present invention, said members (100) include various structural steel members used as beams or columns of steel building structures, structural steel members used in bridge structures, nonferrous metals, and FRP members without any limitation in the material, size, or shape. Although said members can be connected using splice connections or intersecting connections, only splice connections are shown in the illustrations in the following.

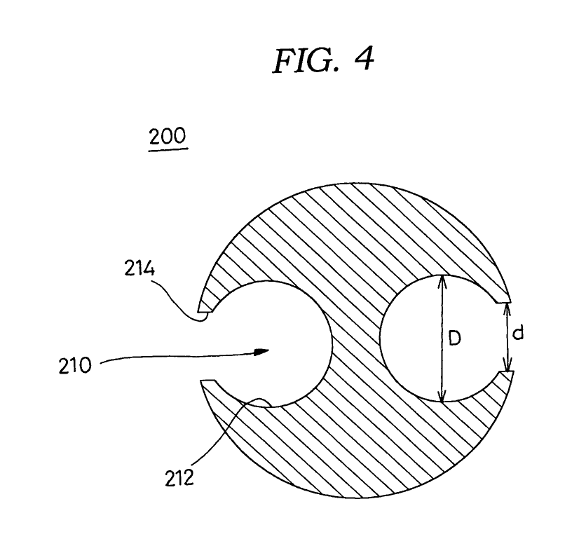

The coupling case (200) of the coupling device of the present invention has at least one connecting slot (210), which is formed to have a round hole whose diameter (D) is larger than the width (d) of the slit (214) for the insertion of the connect member as shown in FIG. 4.

The width of the said coupling case (200) can be made to match the width of the connected member such as the flange width of wide-flange beams. The connecting slot (210) has a round hole that is open at both ends for fillers and wedges to be inserted and a slit (214) for a connected member to be inserted.

The connecting slots (210) of said coupling case (200) can be formed in symmetry as shown in FIG. 4, when the structural members are connected using splice connection. When the structural members meet at right angle, the connecting slots (210) can be formed at right angle correspondingly. The number and location of the connecting slots (210) can be changed variously according to the connection type between the structural members. The shape of the coupling case (200) is not limited to the round shape shown in FIG. 4, but can be rectangular, polygonal, or oval if necessary.

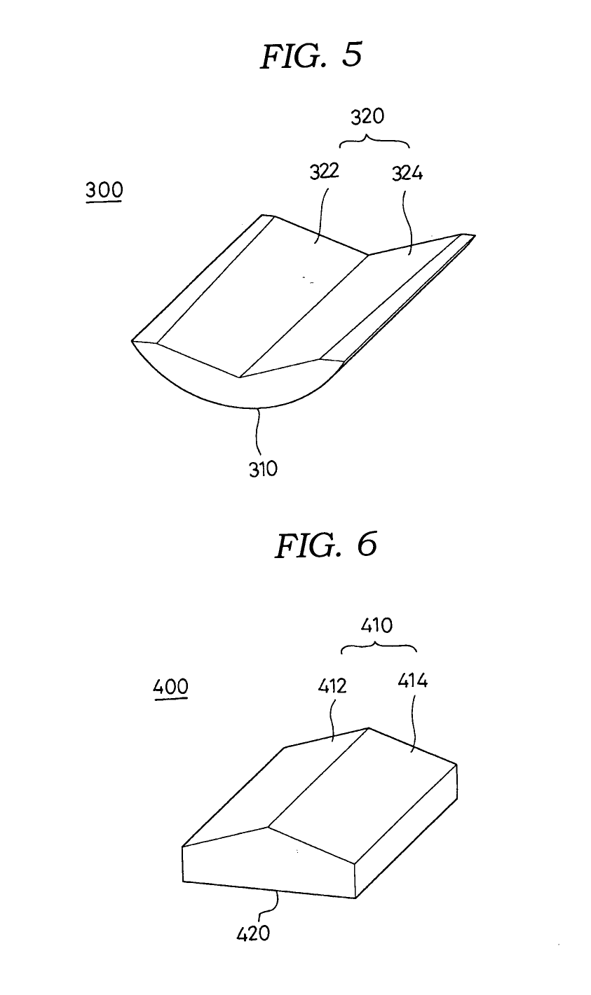

FIG. 5 shows the filler (300) which is one of the components of the coupling device of the present invention, and has the function to put the member (100) and the wedge (400) in close contact. The filler has an outer surface (310) which has the same radius of gyration as the inner surface of the round hole of the connecting slot (210) of the coupling case (200) and an inner surface (320) which touches the wedge (400). The inner surface (320) of the filler has slope side 1 and slope side 2 (322, 324) which are tapered to keep the wedge from coming out of the coupling case.

Said filler (300) can be made in various sizes to take up any variation in the thickness of the structural members, and the inner surface (320) that touches the wedge is mechanically processed to reduce the coefficient of friction.

Moreover, said filler (300) can be made longer than the wedge (400) to take up the dimensional deviation by adjusting the length of insertion. The width and thickness of the inner surface (320) of the filler (300) can be made to be smaller at one end for easier insertion.

FIG. 6 shows the wedge (400) of the coupling device of the present invention. The wedge has an outer surface (410) that has slope side 1 and slope side 2 (412, 414) corresponding to the slope side 1 and slope side 2 (322, 324) of the inner surface (320) of the filler (300) and an inner side (420) that touches the member (100).

The outer surface (410) of said wedge (400) is mechanically processed to reduce the coefficient of friction. If not shown in a figure, the inner surface (420) that touches the member (100) is treated to be rough or have serrations of projection type.

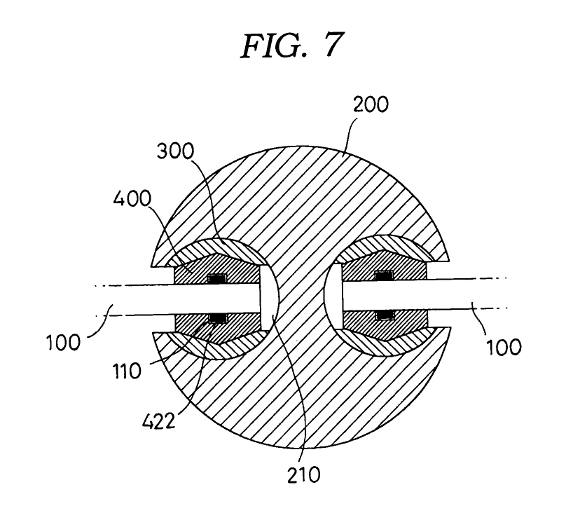

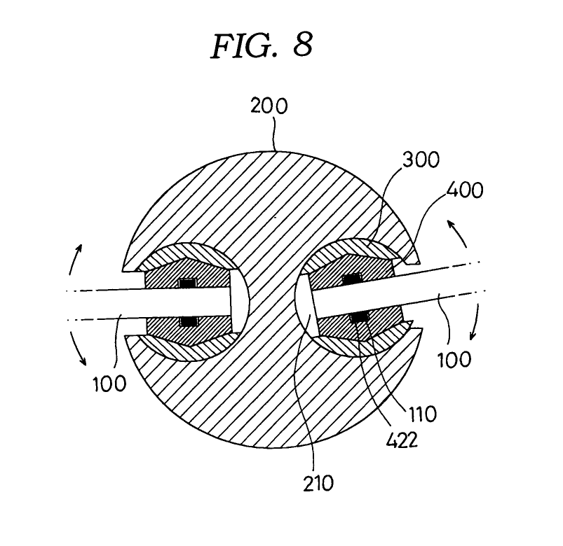

FIG. 7 shows the cross section of the coupling device of the present invention as another Preferred Embodiment and FIG. 8 illustrates the mobility of the structural members connected using the coupling device of FIG. 7.

In this Preferred Embodiment, a stud (110) is attached to the surface of the member (100) that is placed in the connecting slot (210) of the coupling case (200), and a hole (422) corresponding to the stud (110) is formed on the inner surface of the wedge (400) that touches the member. The rest are the same as those of the first Preferred Embodiment.

In this Preferred Embodiment, improved safety can be secured by the bearing connection between the stud (110) and the hole (422) in addition to the initial friction of the contact surface when slip between the member (100) and the wedge (400) occurs due to insufficient contact.

The structural members (100) can move in the connecting slots (210) to some extent and rotate in either direction about the center of the round hole of the connecting slot (210) as shown in FIG. 8 providing the coupling device with some mobility to take up deviation from straightness of structural members (100) due to construction error.

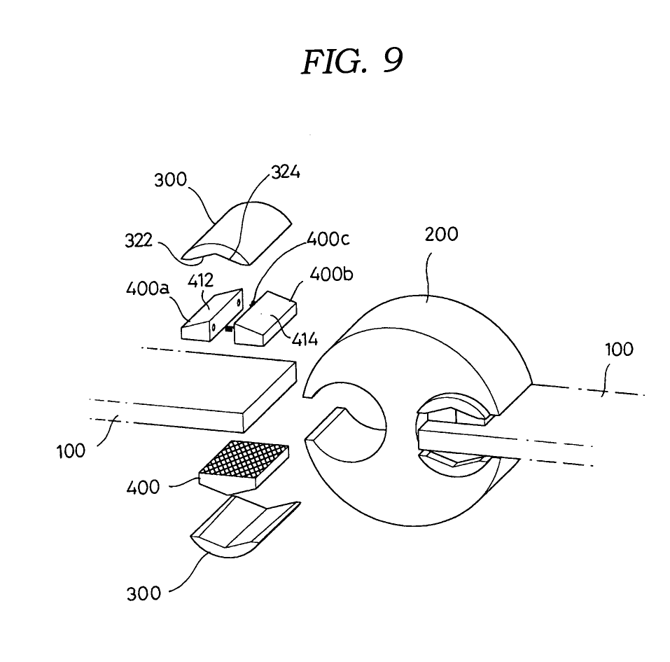

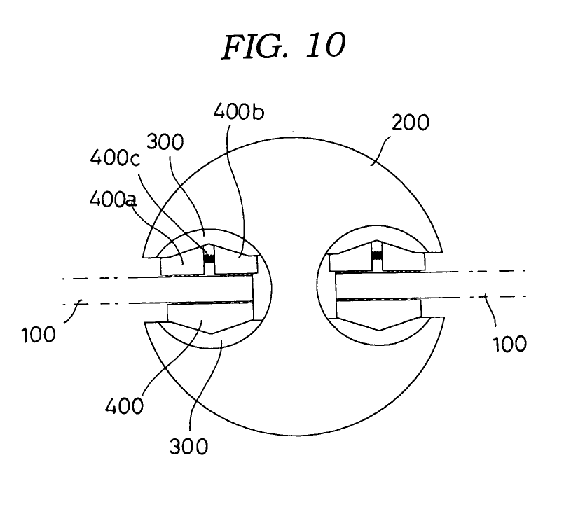

FIG. 9 shows the coupling device of the present invention as another Preferred Embodiment in a disassembled state and FIG. 10 shows the coupling device of FIG. 9 in an assembled state.

In this Preferred Embodiment, the coupling case (200) and the fillers (300) are the same as those of the first and second Preferred Embodiments. The difference is that one wedge (400) on either side of the member (100) is divided in half; that is, the wedge (400) of this Preferred Embodiment is divided into two parts (400a, 400b) along the borderline between slope side 1 (412) and slope side 2 (414), which is transverse to the direction of the member, and springs (400c) are placed between the divided wedges (400a, 400b) to spread them in the connecting slot (210) of the coupling case (200) inducing close contact between the wedges (400a, 400b) and the member (100).

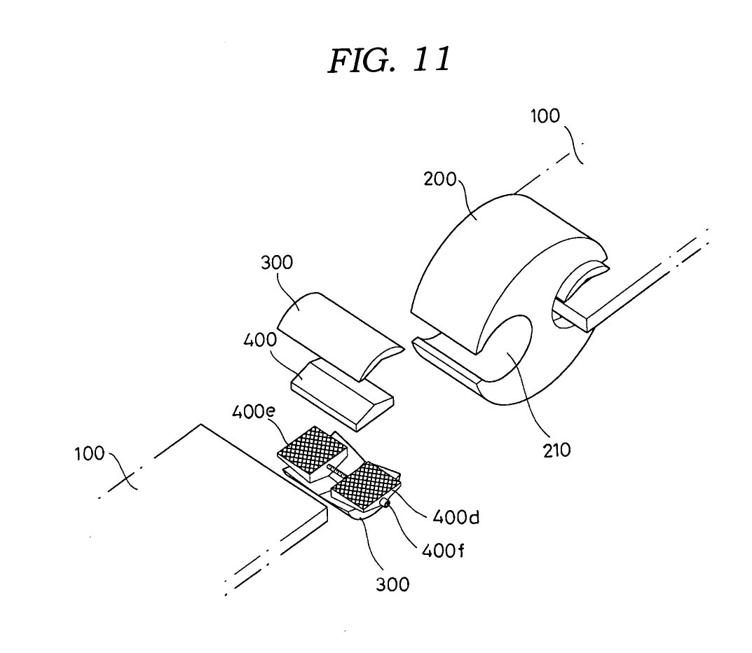

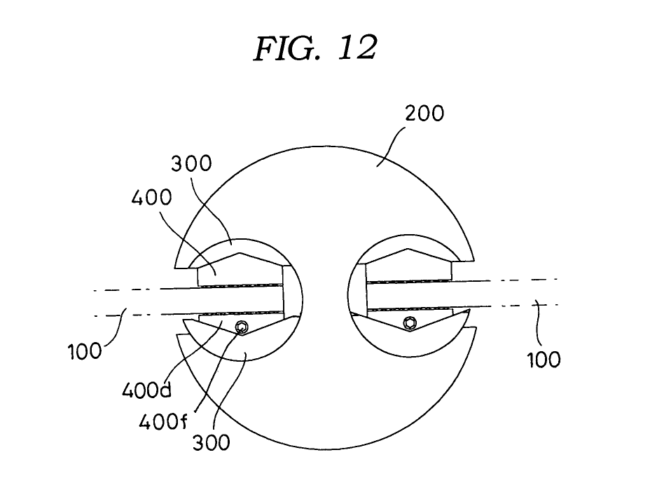

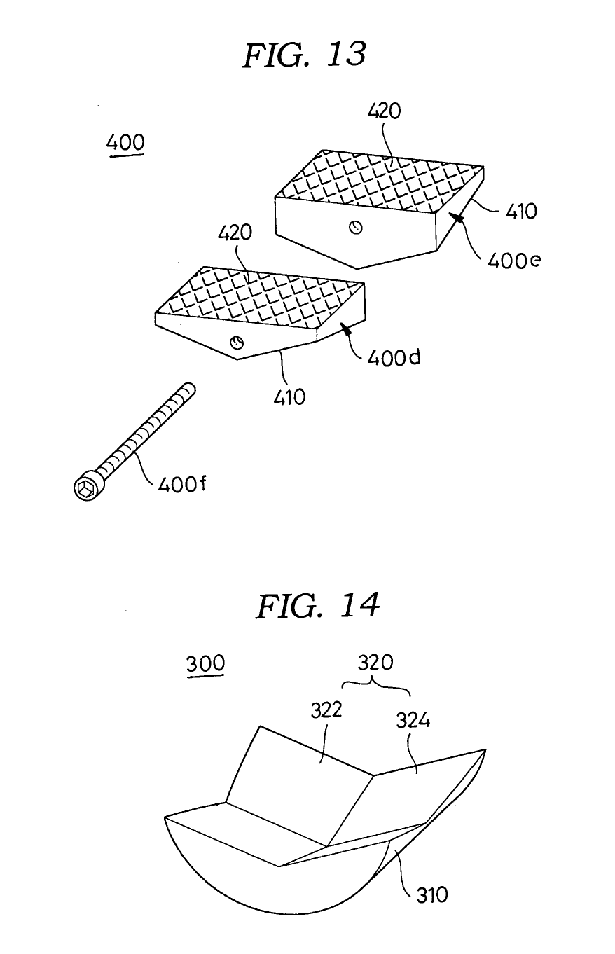

FIG. 11 shows the coupling device of the present invention as another Preferred Embodiment in a disassembled state, and FIG. 12 shows the coupling device of FIG. 11 in an assembled state. FIG. 13 and FIG. 14 show the wedge and the filler of the coupling device of FIG. 11, respectively.

In this Preferred Embodiment, while the coupling case (200) is the same as those of the first to third Preferred Embodiments, the wedge (400) and the filler (300) have different shapes. Unlike that of the third Preferred Embodiment, the wedge (400) is divided into two parts in the direction of the member (transverse to the direction of the wedge). The outer surface of the divided wedges (400d, 400e) is formed to be tapered outwards as shown in FIG. 13 and the inner surface (320) of said filler (300) is formed to be tapered inwards corresponding to the outer surface (410) of said wedge (400) as shown in FIG. 14. A screw-type space adjuster (400f) is provided between the divided wedges (400d, 400e). The wedge (400) can come into close contact with or separate from the member (100) by modulating the space adjuster (400f) to spread or narrow the divided wedges (400d, 400e).

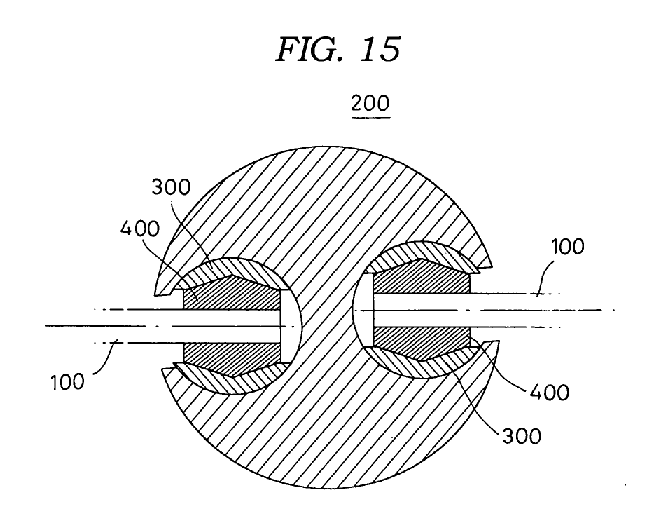

FIG. 15 shows the coupling device of the present invention connecting structural members with different depth. The coupling device of the present invention makes an easy installation possible in the construction site by taking up any difference in thickness of connected structural members (100, 100a) and any variation in depth and deviation from straightness by adjusting the extent of the insertion of the filler (300) or selecting an appropriate size.

### INDUSTRIAL APPLICABILITY

The coupling device of the present invention can connect structural members by a wedge action as the wedge and the member are brought in to close contact by inserting the filler or spreading the wedge after the wedge and the member are placed in the connecting slot of the coupling case. The coupling device of the present invention makes an easy installation possible at the construction site by taking up any difference in thickness of the connected structural members and any variation in depth at the connection. The insertion of the filler brings the wedge into close contact with the member securing the wedge action. If a stud is attached to the member, the stud secures the wedge action when the wedge is not in close contact with member. Split-type wedges can easily take up any difference in member thickness and secure the wedge action by the spreading force of elastic springs or space adjusters reducing the construction time and labor costs greatly compared with the conventional bolted connection and the coupling device of the previous invention.

1. A coupling device for connecting structural members, which comprises a coupling case that has connecting slots, in which structural members to be connected are placed, and a pair of fillers that are placed in said connecting slots to touch the inside of the connecting slots, and wedges that are inserted into the space between said fillers and said members in said connecting slots.

2. The coupling device according to claim 1, in which said coupling slot has a round hole whose diameter (D) is larger than the width (d) of the slit for the insertion of said member.

3. The coupling device according to claim 2, in which said filler has an outer surface which touches the inside of the connecting slot and an inner surface which touches the wedges, the inner surface of the filler having slope side 1 and slope side 2 which are tapered.

4. The coupling device according to claim 3, in which said wedge has an outer surface that has slope side 1 and slope side 2 corresponding to the slope side 1 and slope side 2 of said filler and an inner surface that touches the member.

5. The coupling device according to claim 4, in which said wedge is divided into two parts along the borderline between slope side 1 and slope side 2, which is transverse to the direction of the member.

6. The coupling device according to claim 5, in which springs are placed between said wedges to spread them.

7. The coupling device according to claim 4, in which said wedge is divided into two parts in the direction of the member, which is transverse to the direction of the wedge, the outer surface of the divided wedges is formed to be tapered outwards and the inner surface of said filler is formed to be tapered inwards corresponding to the outer surface of said wedge.

8. The coupling device according to claim 7, in which a screw-type space adjuster is provided between the divided wedges.

9. The coupling device according to claim 4, in which a stud is attached to the surface of said member, and a corresponding hole is formed on the inner surface of said wedge.
